(19) United States
(12) Patent Application Publication
(10) Pub. No.: US 2006/0230045 A1
(43) Pub. Date: Oct. 12, 2006

(54) Assignment of network service name

(75) Inventor: Shinji Konishi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/389,052

(22) Filed: Mar. 27, 2006

(30) Foreign Application Priority Data
Mar. 29, 2005 (JP) 2005-95907

(51) Int. Cl. G06F 17/30

(52) U.S. Cl. 707/10

(57) ABSTRACT

A service providing device connected to a network provides N network services, where N is an integer equal to 2 or greater. For assigning service names to identify N network services, a first common string commonly used in the service names of the N network services is set. The first common string is then stored in a common string storage unit in the service providing device. A string that includes an individual string individually set for each of the N network services and the first common string stored in the common string storage unit is assigned to each of the N network services as the service name.

### CROSS-REFERENCE TO RELATED APPLICATIONS

The present application claims the priority based on Japanese Patent Application No. 2005-095907 filed on Mar. 29, 2005, the disclosure of which is hereby incorporated herein by reference in its entirety.

### BACKGROUND OF THE INVENTION

1. Field of the Invention

This invention relates to technology for assigning service names to identify various network services.

2. Description of the Related Art

Where a service providing device (server) on a network provides multiple network services, in order for a client to be able to utilize the services, it is necessary that the client identifies the server and its services. The server can be identified by an identifier such as an IP address. The network services provided by the server can be designated by a specifier such as port number. Since IP address and port number are represented by numeral strings, a significant burden is imposed on the user when making the various settings needed to utilize network services from the client. Accordingly, it has been attempted to reduce the burden on the user, by assigning, for each of a multiplicity of network services, a character string (service name) identifying the network service, so that network services can be identified by service name.

On the other hand, when the service names are set up individually for each network service, the service names assigned for multiple services provided by a given server may lack commonality or consistency. In some instances, the lack of commonality makes it difficult for the user to ascertain the server in accordance with the service names.

### SUMMARY OF THE INVENTION

An object of the present invention is to enable assigning service names having commonality to network services provided by a given server, so that the user may easily ascertain the server in accordance with the service names.

According to an aspect of the present invention, a method is provided that assigns service names for identifying N network services provided by a service providing device connected to a network, where N is an integer equal to 2 or greater. The method comprises steps of: (a) setting a first common string commonly used in the service names of the N network services; (b) storing the first common string on a common string storage unit in the service providing device; and (c) assigning the service names for the N network services, wherein each service name is a character string that includes an individual string individually set for each of the N network services, and the first common string stored in the common string storage unit.

According to this method, each of service name assigned to N network services includes the first common string stored in common string storage in the service providing device. As a result the user may easily ascertain the server from the service names

The present invention may be realized in various embodiments, for example, a service name setting method and a service name setting device; a computer program for realizing the functions of such a method or a device; a storage medium having such a computer program stored thereon; and data signals embedded in carrier waves including such a computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows the configuration of a network system 100 as an embodiment of the present invention.

FIG. 2 illustrates the configuration of the SPC multifunction device 200.

FIG. 3 illustrates data exchange among the SPC multifunction device 200 and computers PC1, PC2 connected on the LAN.

FIG. 4A depicts an input screen DLB displayed on the computer PC1.

FIG. 4B depicts user modification of the string displayed in the input field ECN.

FIG. 5A depicts a page PT1 to make settings relating to print service under Protocol 1.

FIG. 5B depicts a page PT2 to make settings relating to print service under Protocol 2.

FIG. 5C depicts a page PT3 to make settings relating to print service under Protocol 3.

FIG. 6A depicts a page PT1 to make settings relating to print service under Protocol 1.

FIG. 6B depicts a page PT2a to make settings relating to print service under Protocol 2.

FIG. 6C depicts a page PT3a to make settings relating to print service under Protocol 3.

FIG. 7A depicts user modification of the string displayed in the input field ECN.

FIG. 7B depicts the warning screen INB prompting the user to input a second common name.

FIG. 7C depicts a page PCNb enabling user to input the second common name in the input field ECN2.

FIG. 8A depicts a page PT1 to make settings relating to print service under Protocol 1.

FIG. 8B depicts a page PT2 to make settings relating to print service under Protocol 2.

FIG. 8C depicts a page PT3 to make settings relating to print service under Protocol 3.

### DESCRIPTION OF THE PREFERRED EMBODIMENT

Preferred embodiments of the invention are illustrated with examples in the following order.
A. First Embodiment:
B. Second Embodiment:
C. Third Embodiment:
D. Variations:

### A. First Embodiment

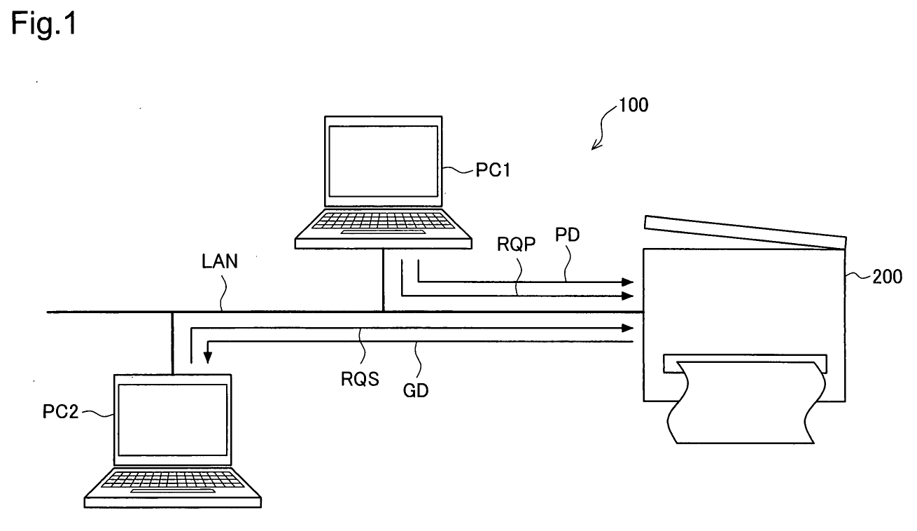

FIG. 1 shows the configuration of a network system 100 as an embodiment of the invention. In the network system 100, two computers PC1, PC2 and a scanner/printer/copier multifunction device 200 (hereinafter termed “SPC multifunction device 200”) are connected on a local area network (LAN).

When a computer PC1 connected on the LAN performs printing with the SPC multifunction device 200, the computer PC1 sends a print request RQP, which is data representing a request to execute printing, and print data PD to the SPC multifunction device 200. When the SPC multifunction device 200 receives the print request RQP, the SPC multifunction device 200 forms an image on a printing medium according to the print data PD supplied by the computer PC1.

On the other hand, when a computer PC2 connected on the LAN is to obtain a scanned image of an original positioned on the scanner bed, the computer PC2 sends to the SPC multifunction device 200 a scan request RQS which is data representing a request to execute scanning of an original. Upon receiving the scan request RQS, the SPC multifunction device 200 scans the original positioned on the scanner bed to generate image GD, and then the generated image data GD is sent to the computer PC2.

In this way, the SPC multifunction device 200, in response to a print request RQP sent from a computer PC1 connected on the LAN, receives print data PD and carries out printing on the basis of the print data PD. The SPC multifunction device 200, in response to a scan request RQS sent from a computer PC2, generates image data GD from an original and sends image data GD. The SPC multifunction device 200 which executes such a various process in response to requests from LAN-connected computers (clients) is termed a “server”, and the various processes executed by the server are termed “network services” or simply “services.”

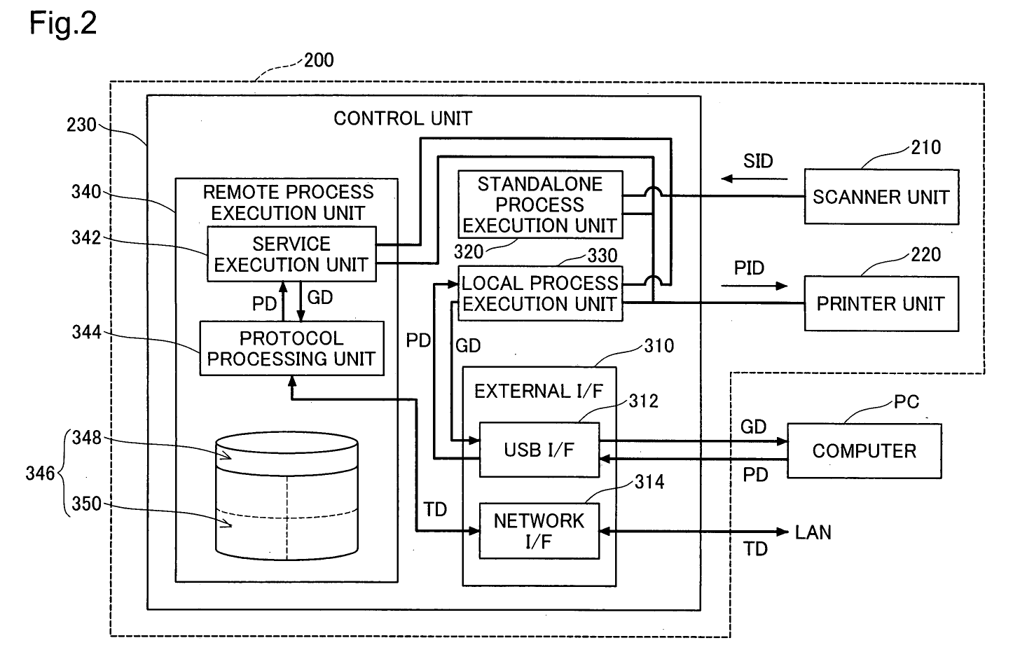

FIG. 2 illustrates the configuration of the SPC multifunction device 200. The SPC multifunction device 200 comprises a scanner unit 210 for scanning an original placed on the scanner bed, a printer unit 220 for forming images on printing media and a control unit 230 for controlling the scanner unit 210 and the printer unit 230.

The control unit 230 comprises an external interface (external I/F) 310, a standalone process execution unit 320, a local process execution unit 330 and a remote process execution unit 340.

The external I/F has a USB interface (USB I/F) 312 and a network interface (network I/F) 314. The SPC multifunction device 200 can connect to a computer PC via the USB I/F 312, and can connect to the LAN via the network I/F 314.

The standalone process execution unit 320 executes various processes that are executable by the SPC multifunction device 200 independently (standalone processes). Standalone processes are executed in response to user operation of control panel (not shown) of the SPC multifunction device 200. A photocopy process to make photocopy from an original is an example of a standalone process. During the photocopy process, the standalone process execution unit 320 acquires scanned image data SID of the original with the scanner unit 210. Print image data PID generated from the scanned image data SID thus acquired is sent to the printer unit 220 which forms a photocopy of the original.

The local process execution unit 330 executes processing in printer mode and processing in scanner mode for the computer PC connected via the USB I/F 312. When carrying out processing in printer mode, the local process execution unit 330 acquires print data PD from the computer PC via the USB I/F 312, and generates print image data PID. By supplying the generated print image data PID to the printer unit 220, the image represented by the print data PD is formed on the printing medium. By means of such processing carried out by the local process execution unit 330, the SPC multifunction device 200 functions as a printer connected to the computer PC.

When the local process execution unit 330 carries out processing in scanner mode, the local process execution unit 330 acquires scanned image data SID of an original with the scanner unit 210. Image processing is performed on the scanned image data SID as appropriate while generating image data GD. The generated image data GD is sent to the computer PC via the USB I/F 312. By means of such processing carried out by the local process execution unit 330, the SPC multifunction device 200 functions as a scanner connected to the computer PC.

The remote process execution unit 340 comprises a service execution unit 342, a protocol processing unit 344 and a service name database 346. The protocol processing unit 344 performs data conversion between transmission data TD exchanged between the client and server over the LAN, and data transferred within the remote process execution unit 340 such as print data PD and image data GD. The protocol processing unit 344 is composed of several modules, described later.

When the SPC multifunction device 200 executes service to perform printing (print service), the protocol processing unit 344 generates print data PD from the transmission data TD supplied via the network I/F 314 and supplies the print data PD to the service execution unit 342. The service execution unit 342 then generates print image data PID from the print data PD, and sends the generated print image data PID to the printer unit 220.

When the SPC multifunction device 200 executes service to perform scanning of an original (scan service), the service execution unit 342 acquires scanned image data SID from the scanner unit 210. The service execution unit 342 generates image data GD from the scanned image data SID, and provides the image data GD to the protocol processing unit 344. The protocol processing unit 344 converts the image data GD to a transmission data TD, and supplies the transmission data TD to the network I/F 314.

The service name database 346 has a common string storage unit 348 and an individual string storage unit 350. This service name database 346 may be composed of nonvolatile memory, such as flash memory.

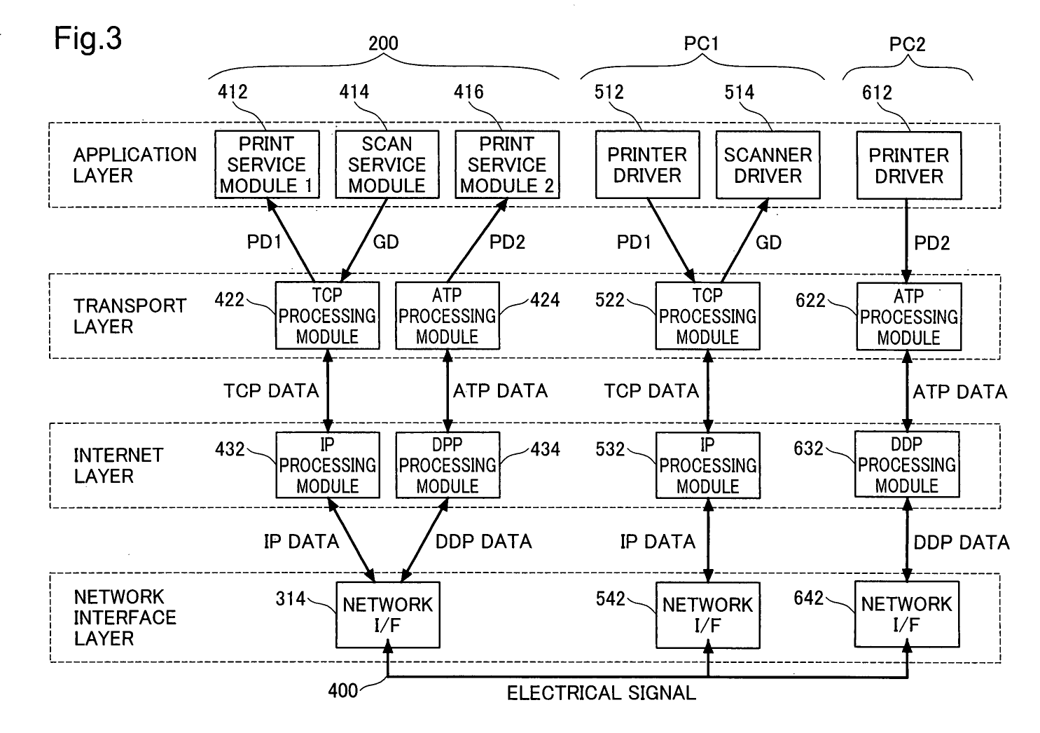

FIG. 3 illustrates data transmission between the SPC multifunction device 200 and the computers PC1, PC2 connected on the LAN. As depicted in FIG. 3, data transmission over the LAN is carried out in accordance with protocols defined for each of four layers, namely, the network interface layer, the internet layer, the transport layer, and the application layer. Protocols such as TCP (Transmission Control Protocol) or ATP (AppleTalk Transaction Protocol) are specified in the transport layer. Protocols such as IP (Internet Protocol) or DDP (Datagram Delivery Protocol) are specified in the internet layer.

Actual data transmission between the SPC multifunction device 200 and the computers PC1, PC2 is handled by modules that perform data processing in accordance with the protocols specified in two layers, namely, the network interface layer and the internet layer. Each of these modules converts data acquired from a module in higher-level layer to lower-layer data according to the corresponding protocol of the module, and supplies the lower-layer data to a module in lower-level layer. Each module also acquires data from a module in lower-level layer, subjects the acquired data to reverse conversion, and supplies the reverse-converted data to a module in higher-level layer.

In the example of FIG. 3, the computer PC1 sends print data PD1 to the SPC multifunction device 200 by TCP/IP protocol. The printer driver 512 of the computer PC1 sends the print data PD1 to a TCP processing module 522 of the computer PC1. The supplied print data PD1 is converted by the TCP processing module 522 of the computer PC1 to data compliant with the TCP protocol (TCP data). This TCP data is then converted by an IP processing module 532 to data compliant with the IP protocol (IP data), which is supplied to the network I/F 542. The network I/F 542 converts the supplied IP data to an electrical signal which is sent out over the LAN cable 400.

The SPC multifunction device 200, via network I/F 314, acquires the IP data from the electrical signal on the LAN cable. The acquired IP data undergoes reverse conversion back to TCP data by an IP processing module 432 and is supplied to a TCP processing module 422. The TCP processing module 422 reconstructs the print data PD1 from the TCP data. The reconstructed print data PD1 is supplied to a first print service module 412. The first print service module 412, which is a part of the service execution unit 342 (FIG. 2), generates print image data PID from the print data PD1, and sends the generated print image data PID to the printer unit 220 (FIG. 2).

Meanwhile, the computer PC2 may send print data PD2 to the SPC multifunction device 200 by AppleTalk (registered trademark) protocol. The print data PD2 from the printer driver 612 of the computer PC2 is converted to data compliant with the DDP protocol (DDP data) by an ATP processing module 622 and a DDP processing module 632. The DDP data is then sent out via the network I/F 642, as an electrical signal to the LAN cable 400.

Via the network I/F 314, the SPC multifunction device 200 acquires the DDP data from the electrical signal on the LAN cable. The print data PD2 is reconstructed from the acquired DDP data by a DDP processing module 434 and an ATP processing module 424. The reconstructed print data PD2 is presented to a second print service module 416. The second print service module 416, which is part of the service execution unit 342, generates print image data PID from the print data PD2, and sends the generated print image data PID to the printer unit 220.

In the example of FIG. 3, the SPC multifunction device 200 transmits image data GD to the computer PC2 by the TCP/IP protocol. A scan service module 414, which is part of the service execution unit 342, acquires scanned image data SID from the scanner unit 210, and generates image data GD. The generated image data GD is converted to IP data by the TCP processing module 422 and the IP processing module 432. The IP data is then sent out via the network I/F 314, as an electrical signal to the LAN cable 400.

Via the network I/F 542, the computer PC1 acquires the IP data from the electrical signal on the LAN cable. The image data GD is reconstructed from the acquired IP data by the IP processing module 532 and the TCP processing module 422. The reconstructed image data GD is supplied to the scanner driver 514 of the computer PC1.

In the example of FIG. 3, the SPC multifunction device 200 is portrayed as providing three services, namely, two print services and one scan service. In general, the SPC multifunction device 200 is able to provide N services, where N is an integer equal to 2 or greater. The value of N depends on the number of service categories and the number of usable protocols. Each of these N services is assigned a name for allowing the clients to identify the service.

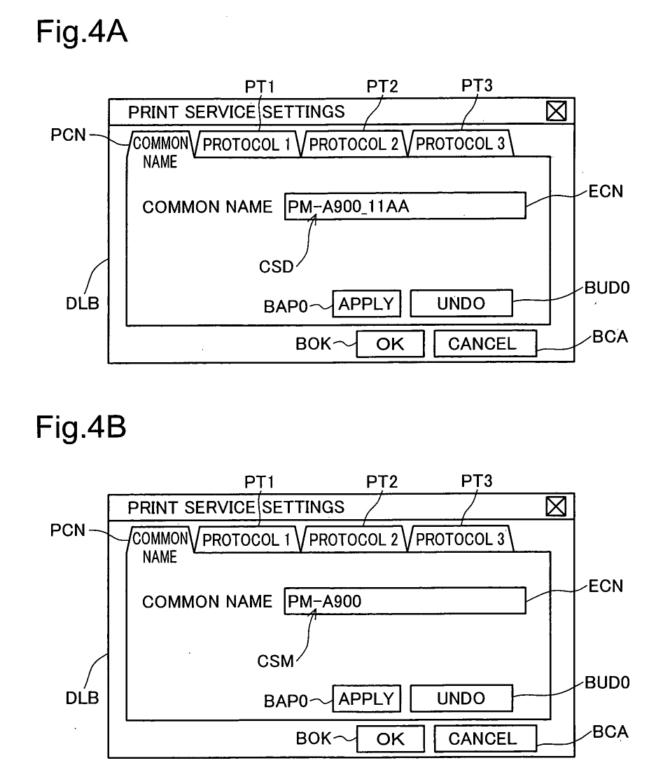

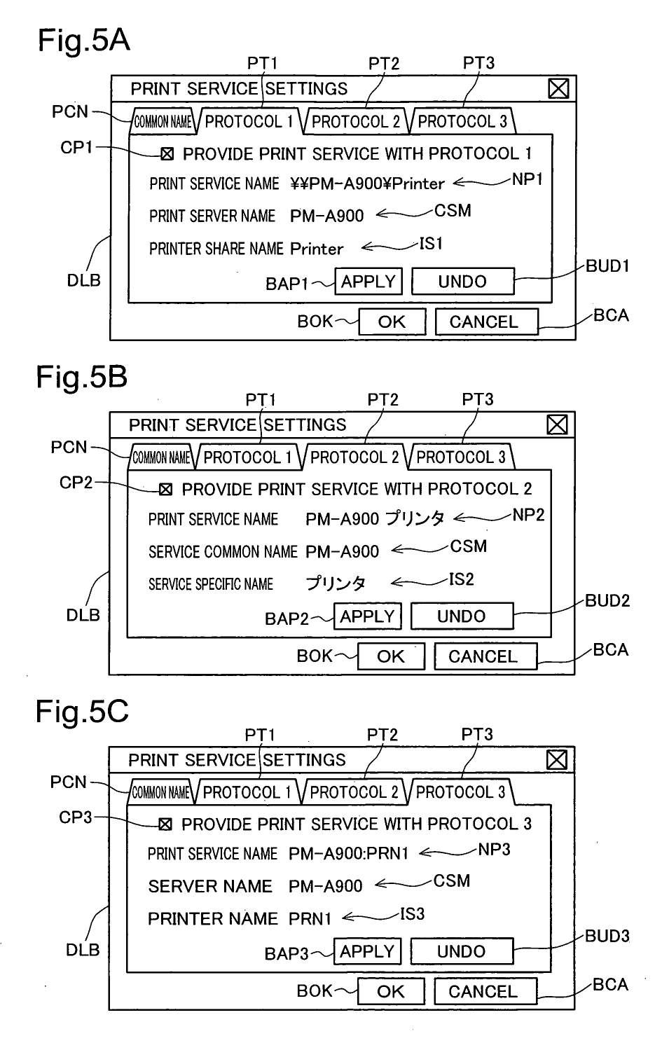

FIG. 4A through FIG. 5C illustrate the way to make settings relating to the multiple print services provided by the SPC multifunction device 200 (FIG. 1) with the computer PC1 (FIG. 1). The settings relating to print services can be made, for example, by executing a computer program running on the computer PC1 for setting up print services. By executing the computer program, the computer PC1 first searches for the SPC multifunction device 200 connected on the LAN. The computer PC1 then acquires the common string stored in the common string storage unit 348 (FIG. 2) of the SPC multifunction device 200. The computer PC1 also acquires a plurality of individual strings stored in the individual string storage unit 350 (FIG. 2) set for each of the print services under the plurality of protocols such as TCP/IP protocol, AppleTalk protocol and NBF (NetBIOS Frame) protocol.

By means of executing the computer program, an input screen (dialog box) DLB as shown in FIG. 4A is displayed on the computer PC1. The dialog box DLB has four pages: a page PCN for inputting a common name that constitutes the common part of the service names; and pages PT1˜PT3 to make settings relating to print services for each usable protocol. The user can switch among these multiple pages by clicking on the page name area displayed at the top of each page (these are typically called “tabs”) with a mouse or other pointing device.

In addition to the four pages PCN and PT1˜PT3, the dialog box DLB also has an “OK” button BOK and a “Cancel” button BCA. If the user clicks the “OK” button, the various settings for the SPC multifunction device 200 are made according to the settings entered to the four pages PCN and PT1˜PT3, and the computer program terminates. If the user clicks the “Cancel” button BCA, the computer program terminates, discarding any changes made to settings in the four pages PCN and PT1˜PT3.

The common name input page PCN has an input field ECN enabling the user to input a character string. In the input field ECN a character string acquired from the common string storage unit 348 is displayed as the default common name. In the example of FIG. 4A, since the string CSD (PM-A900_{—}11AA) is stored in the common string storage unit 348 of the SPC multifunction device 200, the string CSD is displayed as a default value. The string CSD is a combination of the model type “PM-A900” of the SPC multifunction device 200 and the last four hexadecimal numbers “11AA” of the MAC address uniquely assigned to each network I/F 314, connected by an underline “_”.

FIG. 4B depicts user modification of the string displayed in the input field ECN. In the example of FIG. 4B, the user has modified the default common string CSD to another common string CSM. If the user clicks on the “Apply” button BAPO displayed on the page PCN after the modification of the common string, the modified common string CSM is transmitted to the SPC multifunction device 200 and stored in the common string storage unit 348. On the other hand, if the user clicks the “Undo” button BUDO displayed on the page PCN, the string stored in the common string storage unit 348 of the SPC multifunction device 200 is reacquired, and the common string is restored to the default common string CSD.

In the example of FIG. 4B, the user-modified common string CSM is composed of characters usable in service names under all of the three protocols employed in provided services, namely, the alphabetic characters, the numeric characters, the hyphen “-”, and the underline “_”. Thus, the user-modified common string CSM is sent as-is to the SPC multifunction device 200 and stored in the common string storage unit 348. On the other hand, if the user-modified string includes a character, such as a space, that cannot be used as a service name under at least one of the three protocols employed in provided services, the common name reverts to the default common string CSD (FIG. 4A).

FIG. 5A depicts a page PT1 to make settings relating to print service under Protocol 1, such as NBF protocol, displayed on the dialog box DLB. On page PT1, a checkbox CP1 for specifying whether the SPC multifunction device 200 provides print service under Protocol 1 is displayed. The user, by putting a checkmark in the checkbox CP1, can set the SPC multifunction device 200 to provide print service under Protocol 1. In the example FIG. 5A, since a checkmark has been put in the checkbox CP1, the SPC multifunction device 200 provides print service under Protocol 1.

In Protocol 1, the print service is identified by the name of the print server providing the print service, and the printer share name. In the example of FIG. 5A, the common string CSM is used as the print server name, and an individual string IS1 set for the print service under Protocol 1 is used as the printer share name. In Protocol 1 the print service name is a string composed of two consecutive yen symbols “¥¥”, followed by the print server name and the printer share name connected by a yen symbol “¥”. Thus, the print service name assigned to print service provided by the SPC multifunction device 200 under Protocol 1 is set to a string NP1 that includes the common string CSM and the individual string IS1, as shown in FIG. 5A.

FIG. 5B depicts a page PT2 to make settings relating to print service under Protocol 2, such as AppleTalk protocol, displayed on the dialog box DLB. The page PT2 shown in FIG. 5B differs from the page PT1 shown in FIG. 5A in that the print service name NP2 and the individual string IS2 are different; that the common string CSM is displayed as the “service common name”; and that the individual string IS2 is displayed as the “service specific name.” In other respects, it is similar to the page PT1.

In Protocol 2, the print service name is represented by a single string which may be composed of arbitrary characters including a space. In the example of FIG. 5B, a string NP2 is used as the print service name, the string NP2 consisting of the common string CSM and an individual string IS2 set for the print service under Protocol 2, connected by a space. As shown in FIG. 5B, the print service name NP2 assigned to the print service of the SPC multifunction device 200 under Protocol 2 includes the common string CSM and the individual string IS2.

FIG. 5C depicts a page PT3 to make settings relating to print service under Protocol 3, such as TCP/IP protocol, displayed on the dialog box DLB. The page PT3 shown in FIG. 5C differs from the page PT1 shown in FIG. 5A in that the print service name NP3 and the individual string IS3 are different; that the common string CSM is displayed as the “server name”; and that the individual string IS3 is displayed as the “printer name.” In other respects, the page PT3 is similar to the page PT1.

In Protocol 3, the print service is identified by the name of the server providing the print service, and the printer name. In the example of FIG. 5C, the common string CSM is used as the server name, and the individual string IS3 set for the print service under Protocol 3 is used as the printer name. In Protocol 3, the print service name is represented by a string composed of the server name and the printer name connected by a colon (:). Thus, the print service name NP3 assigned to the print service of the SPC multifunction device 200 under Protocol 3 includes the common string CSM and the individual string IS3.

In FIG. 4A through FIG. 5C, settings made for the various print services are shown; settings for the scan service provided by the SPC multifunction device 200 are made in similar manner. In this case, a string that, similar to the print service name, includes the common string CSM and an individual string set on service-by-service basis is used in the scan service name.

In this way, in the first embodiment, the common string commonly used in the service names that identify a plurality of services provided by the SPC multifunction device 200 is stored in the common string storage unit 348. Since the plurality of services provided by the SPC multifunction device 200 are identified by service names that include the common string stored in the common string storage unit 348, the user can more readily ascertain the SPC multifunction device 200 which provides the service in accordance with the service name.

In the first embodiment, user modification of the common string is permitted. However, where a common string is set in advance and stored in the common string storage unit, its modification by the user may be prohibited. For example, modification of the common string may be enabled for a specific administrator only so that the non-authorized users always use the preset common string assign service names.

In the first embodiment, the individual strings are acquired from the individual string storage unit 350 of the SPC multifunction device 200 so that strings that each include the common string and an individual string are assigned to services as service names. However, the individual strings constituting service names may be recorded onto a medium having recorded thereon a computer program for setting up print services. In this case the individual string storage unit 350 of the SPC multifunction device may be omitted.

### B. Second Embodiment

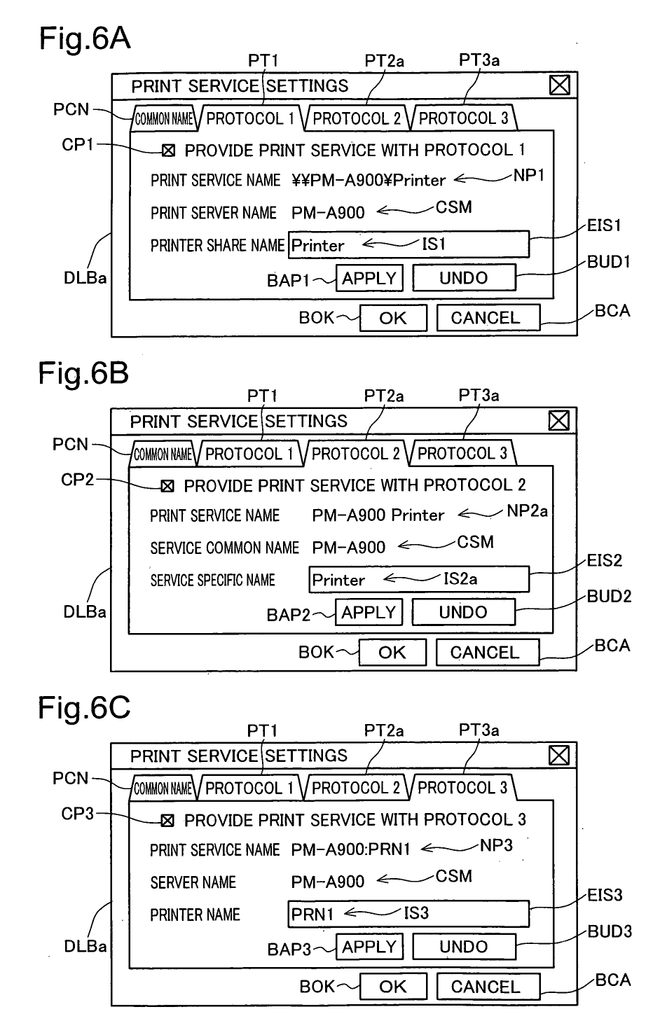

FIG. 6A through FIG. 6C illustrate the way to make settings relating to the multiple print services provided by the SPC multifunction device 200 (FIG. 1). The second embodiment differs from the first embodiment in that user modification of individual strings is permitted. Other aspects are the same as the first embodiment.

The dialog box DLBa shown in FIG. 6A through FIG. 6C differs from the dialog box DLB of the first embodiment shown in FIG. 5A through FIG. 5C in that the dialog box DLBa has pages PT1a˜PT3a instead of pages PT1˜PT3.

As shown in FIG. 6A through FIG. 6C, input fields EIS1˜EIS3 enabling the user to input character strings are provided respectively in the three pages PT1a ˜PT3a. As shown in FIG. 6A through FIG. 6C, individual strings IS1˜IS3 stored in the individual string storage unit 350 (FIG. 2) are displayed as the default individual strings in these input fields EIS1˜EIS3.

FIG. 6B depicts modification of the string displayed in the input field EIS2 by the user. In the example of FIG. 6B, the user has modified the default individual string to the individual string IS2a. If the user clicks the “Apply” button BAP2 displayed on the page PT2a after the modification of the individual string, the modified individual string IS2a is transmitted to the SPC multifunction device 200 and stored in the individual string storage unit 350. As shown in FIG. 6B, the string NP2a that includes the common string CSM and the individual string IS2a, connected by a space is assigned to a print service name. On the other hand, if the user clicks the “Undo” button BUD2 displayed on the page PT2a, the string stored in the individual string storage unit 350 of the SPC multifunction device 200 is reacquired, and the individual string is restored to its default value.

In this way, in the second embodiment as in the first embodiment, the plurality of services provided by the SPC multifunction device 200 are identified by service names that include the common string stored in the common string storage unit 348. As a result the user can more readily ascertain the SPC multifunction device 200 providing the service from the service name. Additionally, in the second embodiment, the user can modify appropriately the individual strings. The user may assign the desired service name easily by modifying the individual string used in a service name.

### C. Third Embodiment

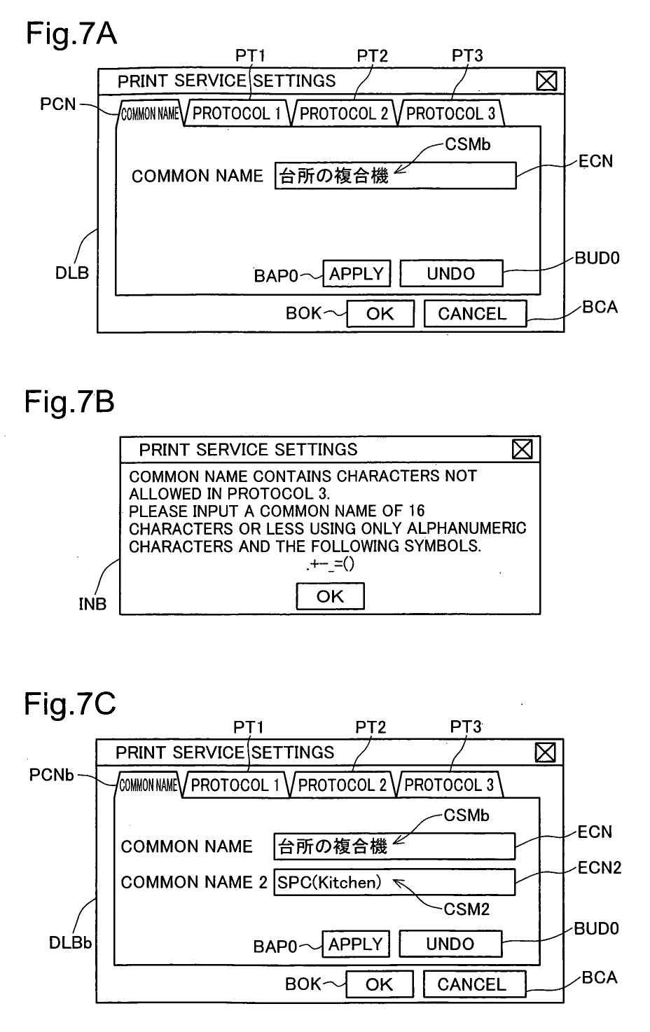

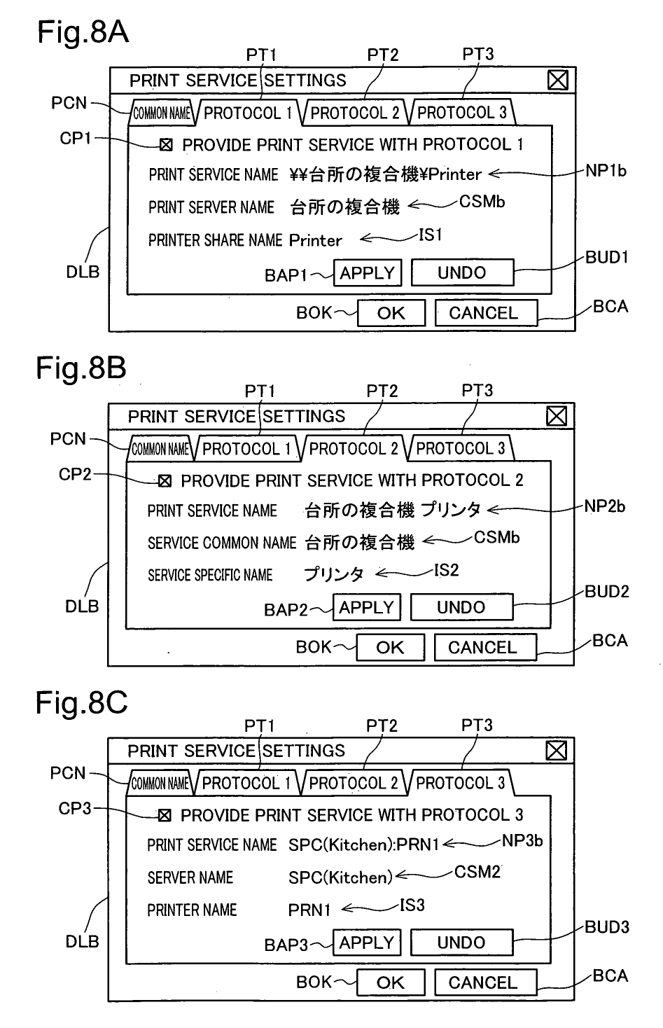

FIG. 7A through FIG. 8C illustrate the way to make settings relating to the multiple print services provided by the SPC multifunction device 200 (FIG. 1) with the computer PC1 (FIG. 1).The third embodiment differs from the first embodiment in that a plurality of common strings are used for generating print service names. Other aspects are the same as the first embodiment.

FIG. 7A differs from FIG. 4A in that the common string CSMb modified by the user contains kanji and hiragana. In the example of FIG. 7A, only characters such as alphabetic characters can be used for service names under Protocol 3. Since a service name includes a common string CSMb that contains kanji and hiragana, as depicted in FIG. 7A, there is a risk that identification of the service with the service name is impossible in Protocol 3.

Accordingly, in the third embodiment, the warning screen INB shown in FIG. 7B is displayed. The warning screen INB notifies the user that the common string CSMb entered as the common name contains characters that are not allowed for service names under Protocol 3, and prompts the user to input a second common name using characters that are allowed for service names under Protocol 3.

When the user then clicks the “OK” button on the warning screen INB, a dialog box DLBb enabling input of two common names is displayed as shown in FIG. 7C. The dialog box DLBb of FIG. 7C differs from the dialog box DLB of FIG. 7A in that the former has an additional input field ECN2 enabling the user to input character string. In other respect the dialog box DLBb of FIG. 7C is the same as the dialog box DLB of FIG. 7A.

When the user, in accordance with the instructions on the warning screen INB, enters a second common string CSM2 into the input field ECN2 and clicks the “Apply” button BAPO, the two common strings CSMb, CSM2 are transmitted to the SPC multifunction device 200 and the two common strings CSMb, CSM2 are stored in the common string storage unit 348 (FIG. 2).

FIG. 8A and FIG. 8B depict display of pages PT1, PT2 to make settings relating to services under Protocol 1 and Protocol 2. FIG. 8A differs from FIG. 5A of the first embodiment in that the common string CSMb contains kanji and hiragana, and in that the string assigned to the print service name NPlb contains the common string CSMb. In other respects it is the same as FIG. 5A. Similarly, FIG. 8B differs from FIG. 5B of the first embodiment in that the common string CSMb contains characters kanji and hiragana, and in that the string assigned to the print service name NP2b that contains the common string CSMb. In other respects it is the same as FIG. 5B.

FIG. 8C depicts display of a page PT3 to make settings relating to services under Protocol 3. FIG. 8C differs from FIG. 5C of the first embodiment in that the second common string CSM2 that contains only characters allowed in Protocol 3 is assigned to the server name, and in that the string assigned to the print service name NP3b contains the common string CSM2. In other respects it is the same as FIG. 5C.

As shown in FIG. 8A through FIG. 8C, in the third embodiment, strings NP1b, NP2b that contain the common string are assigned respectively as the print service names identifying the print service under Protocol 1 and Protocol 2. On the other hand, under Protocol 3, in which the common string CSMb contains characters not allowed for use in print service names, the string NP3b that contains the common string CSM2 is assigned to the print service name.

In FIG. 7A through FIG. 8C, the common string CSM2 is used only for print service names under Protocol 3, the common string CSM2 could also be used for scan service names under Protocol 3.

In this way, in the third embodiment, by using multiple common strings, a plurality of service names assigned to services under plural protocols may include a common string, as long as the common name consists of characters usable in the plural protocols. In consequence, the user may set a common string more flexibly, and may more easily assign service names including the common string in the desired manner.

Additionally, whereas in the third embodiment, the user is prompted to set the second common string CSM2 on the basis of the common string CSMb which has been entered by the user. However, it would be also acceptable to set the two common strings in advance, and to store the strings in the common string storage unit. In the same manner as the first embodiment, modification of the common strings may be enabled for a specific administrator only so that the non-authorized users always use the preset common strings, for example.

### D. Variations

The invention is not limited to the embodiments and examples described hereinabove, and can be reduced to practice in various other ways without departing from the spirit thereof, such as the alternative forms described below, for example.

### D1. Variation 1

In the embodiments hereinabove, service name assignment technique of the present invention is applied to the assignment of service names for identifying print services and scan services provided by the SPC multifunction device 200. The invention is also applicable to the assignment of service names for identifying services provided by any service providing device, as long as the service providing device provides a plurality of services according to a plurality of protocols. For example, the invention is applicable to the assignment of service names for identifying storage services provided by a file server, where the file server provides a plurality of storage services allowing clients to share files under the plurality of protocols.

### D2. Variation 2

In the embodiments hereinabove, print service names are assigned by means of executing a computer program for setting up print services on the computer PC1. However, assignment of print service names can be performed by using any device which is LAN-connected and able to execute the program. For example, the SPC multifunction device 200 may be endowed with web server functionality, with the SPC multifunction device 200 transferring to clients a common string input page, in the form of a web page that can be displayed in a client's browser. In this case, the SPC multifunction device 200 can acquire a user-input string sent from a client, and assign a print service name using a common string generated according to the acquired string.

### D3. Variation 3

In the embodiments hereinabove, assignment of print service name is performed by the computer PC1 connected to the SPC multifunction device 200 via a LAN. Assignment of print service name may be performed by any device, provided that it is capable of setting common strings, and storing the common strings in a common string storage unit. Assignment of service names may be carried out, for example, with the SPC multifunction device 200, or a computer PC connected to the SPC multifunction device 200 via the USB I/F as shown in FIG. 2. Assignment of service names with the SPC multifunction device 200 may be carried out, for example; by user operation of a software keyboard displayed on the control panel of the SPC multifunction device 200. In this case, assignment of service names can be carried out, for example, by acquiring a character string input by the user from the software keyboard, and storing the acquired string as the common string in the common string storage unit.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method for assigning service names for identifying N network services provided by a service providing device connected to a network, where N is an integer equal to 2 or greater, the method comprising the steps of:
(a) setting a first common string commonly used in the service names of the N network services;
(b) storing the first common string in a common string storage unit in the service providing device; and
(c) assigning the service names to the N network services, wherein each service name is a character string that includes an individual string individually set for each of the N network services, and the first common string stored in the common string storage unit.

2. A method according to claim 1, wherein the step (a) includes the steps of:
displaying a common string input screen enabling a user to enter an input string for use as the first common string; and
if the input string entered by the user cannot be used as the first common string, then prompting the user to enter a reinput string usable as the first common string, and setting the reinput string input by the user as the first common string.

3. A method according to claim 1, wherein the service providing device is capable of providing M network services in addition to the N network services, where M is an integer equal to 2 or greater,
the method further comprising the steps of
(d) setting a second common string, different from the first common string, commonly used in the service names of the M network services;
(e) storing the second common string in the common string storage unit; and
(f) assigning service names to the M network services, wherein each service name is a character string that includes an individual string individually set for each of the M network services, and the second common string stored in the common string storage unit.

4. A method according to claim 3, wherein
the step (a) includes the steps of:
displaying a common string input screen enabling a user to enter an input string for use as the first common string; and
if the input string entered by the user is not usable as the first common string, then prompting the user to enter a reinput string usable as the first common string, and setting the reinput string entered by the user as the first common string; and
the step (d) includes the step of:
if the input string entered by the user is usable as the second common string, then setting the input string as the second common string.

5. A method according to claims 1 further comprising the steps of
displaying an individual string input screen enabling a user to enter character strings for use as the individual strings; and
setting the strings used as the individual strings entered by the user, as the individual strings.

6. A method according to claims 1, wherein the step (a) includes the steps of:
transferring, by the service providing device, to a client computer connected to the network, a browser page for display in a browser on the client computer, wherein the page is a common string input page enabling a user of the client computer to enter an input string for use as the common string;
receiving, by the service providing device, the input string sent from the client computer; and
generating, by the service providing device, the common string according to the received input string.

7. A computer program product for assigning service names to identify N network services provided by a service providing device connected to a network, where N is an integer equal to 2 or greater, the computer program product comprising:
a computer-readable medium; and
a computer program stored on the computer-readable medium, the computer program including:
a first program for causing a computer to set a common string commonly used in the service names of the N network services;
a second program for causing the computer to store the common string in a common string storage unit in the service providing device; and
a third program for causing the computer to assign service names to the N network services, wherein each service name is a character string that includes an individual string individually set for each of the N network services, and the common string stored in the common string storage unit.

8. A device connected to a network providing N network services, where N is an integer equal to 2 or greater, the device comprising:
a common string setting unit configured to set a common string commonly used in the service names of the N network services;
a common string storage unit configured to store the common string; and
a service name assignment unit configured to assign service names to the N network services, wherein each service name is a character string that includes an individual string individually set for each of the N network services, and the common string stored in the common string storage unit; wherein
the common string setting unit has:
an input page transfer unit that transfers, to a client computer connected to the network, a browser page for display in a browser on the client computer, wherein the page is a common string input page enabling a user of the client computer to enter an input string for use as the common string;
an input string receiving unit that receives the input string sent from the client computer; and
a common string generating unit that generates the common string according to the received input string.
